(19) United States
(12) Patent Application Publication
(10) Pub. No.: US 2007/0206352 A1
(43) Pub. Date: Sep. 6, 2007

(54) FIXTURE STRUCTURE OF ROTATING SHAFT

(75) Inventor: Shih-Chi Lee, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei (TW)

(21) Appl. No.: 11/457,821

(22) Filed: Jul. 17, 2006

(30) Foreign Application Priority Data
Feb. 23, 2006 (TW) 95106038

(51) Int. Cl. G06F 1/16

(52) U.S. Cl. 361/686

(57) ABSTRACT

A fixture structure of a rotating shaft, suitable for fixing an insert module is provided, which comprises a mainframe, a latching shaft, a resetting component and a latching rod. The mainframe has an accommodating slot to accommodate the insert module. The latching shaft is pivoted at a side of the accommodating slot of the mainframe, and has a retainer and a bulge. When the retainer is engaged with a recess of the insert module, the insert module is fixed within the accommodating slot. The resetting component is disposed on the mainframe for driving the latching shaft that has been forced to rotate returning to the original position. The latching rod is forced to move, so as to bear against and push the bulge of the latching shaft, thereby driving the latching shaft to rotate.

### CROSS-REFERENCE TO RELATED APPLICATION

This application claims the priority benefit of Taiwan application serial no. 95106038, filed Feb. 23, 2006. All disclosure of the Taiwan application is incorporated herein by reference.

### BACKGROUND OF THE INVENTION

1. Field of the Invention

The present invention relates to a fixture structure of an insert module, and more particularly, to a fixture structure of a rotating shaft for an insert module of a notebook computer.

2. Description of Related Art

To meet the modern life style, many electronic recording apparatuses have become relatively light, small and portable. Examples of the portable electronic recording apparatus are notebook computer, personal digital assistant (PDA), and etc. Taking the notebook computer as an example, it has relative light weight and small volume through miniaturizing the volume of each electronic part and that of the housing. Moreover, the battery of the common notebook computer is mostly fixed to the notebook in the form of an insert module, such that the operation time of the notebook computer is prolonged by changing the battery. Therefore, in order to achieve miniaturization, not only the volume of the electronic parts of the notebook computer must be reduced, but also the fixture structure used for fixing the battery of the notebook is also required to be reduced in volume.

The conventional battery-fixing structure for the notebook computer usually fixes the battery within the battery-accommodating slot of the notebook computer by utilizing a linearly movable snapping tenon to match with the snapping slot. The user may remove the battery from the battery-accommodating slot of the notebook computer by releasing the structure interference between the snapping tenon and the snapping slot. However, the design of the linearly movable snapping tenon and snapping slot requires a relative long moving stroke to provide the function of structure interference. When the battery-accommodating slot is adjacent to the side of the housing, the space there-between may not provide a relatively long moving stroke to accommodate the conventional battery-fixing structure, which thus restricts or limits miniaturization of the notebook computer.

### SUMMARY OF THE INVENTION

In view of the above, the object of the present invention is to provide a fixture structure of a rotating shaft for fixing an insert module.

In accordance with the above and or other objects, the present invention provides a fixture structure of a rotating shaft, suitable for fixing an insert module. The fixture structure of a rotating shaft comprises a mainframe, a latching shaft, a first resetting component and a latching rod. The mainframe has an accommodating slot to accommodate the insert module. The latching shaft is pivoted at one side of the accommodating slot of the mainframe, and has a retainer and a bulge. When the retainer is engaged with a recess of the insert module, the insert module is fixed within the accommodating slot. The first resetting component is disposed on the mainframe and is used to drive the latching shaft that has been forced to rotate to return to the original position. The latching rod is disposed at another side of the accommodating slot of the mainframe and is forced to move and substantially perpendicular to the latching rod, so as to bear against and push the bulge of the latching shaft, thereby driving the latching shaft to rotate, such that the retainer is disengaged from the recess of the insert module.

In an embodiment of the present invention, the latching rod is slidably disposed on the mainframe.

In an embodiment of the present invention, when the insert module is placed into a first position of the accommodating slot, the insert module pushes the retainer to drive the latching shaft to rotate, and meanwhile, the first resetting component stores a potential energy. When the insert module is forced to move from the first position to a second position, the first resetting component releases the potential energy, thereby driving the latching shaft that has been forced to rotate to return to the original position, thus, the retainer is engaged with the recess of the insert module.

In an embodiment of the present invention, the first resetting component is an elastomer or a torsion spring. When the first resetting component is a torsion spring, the first resetting component is located around the latching shaft.

In an embodiment of the present invention, the fixture structure of a rotating shaft further comprises a second resetting component disposed on the mainframe and is used to drive the latching rod, which has been forced to move, to return to the original position. Moreover, the insert module further has a bump, and the latching rod further has a stopper. When the latching rod bears against the bulge after being forced to move, the stopper is engaged with the bump for limiting the position of the latching rod, such that the latching rod is not driven by the second resetting component to return to the original position of the latching rod.

In an embodiment of the present invention, the second resetting component is an elastomer or a spring.

As described above, the rotation of the latching shaft is used to replace the movement of the conventional liner-movable latching tenon so as to provide the function of structure interference. Therefore, the operation space may be reduced.

In order to make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a perspective view of a fixture structure of a rotating shaft before being applied to a notebook computer to fix the insert module according to an embodiment of the present invention.

FIG. 1B is a perspective view of the fixture structure of a rotating shaft in FIG. 1A after being applied to fix the insert module.

FIG. 2 is a partial enlarged view of FIG. 1A.

FIG. 3 is a perspective view of a part of the components of the fixture structure of a rotating shaft and the insert module of FIG. 1A.

FIG. 4A is a top view of the insert module of FIG. 3.

FIG. 4B is a rear view of the insert module of FIG. 3.

FIGS. 5A-5D are bottom views of the process of assembling the insert module of FIG. 1 to the fixture structure of a rotating shaft.

FIGS. 6A-6D are rear views of the process of assembling the insert module of FIG. 1 to the fixture structure of a rotating shaft.

FIGS. 7A-7D are bottom views of the process of detaching the insert module of FIG. 1 from the fixture structure of a rotating shaft.

FIGS. 8A-8D are rear views of the process of detaching the insert module of FIG. 1 from the fixture structure of a rotating shaft.

### DESCRIPTION OF EMBODIMENTS

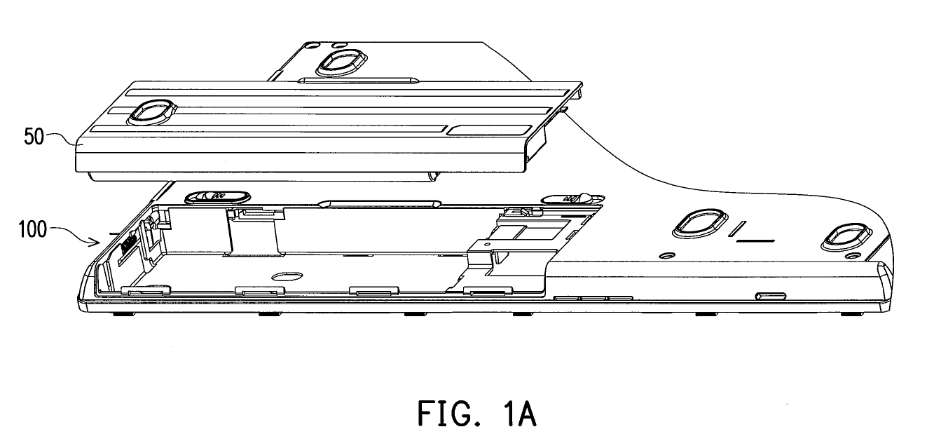

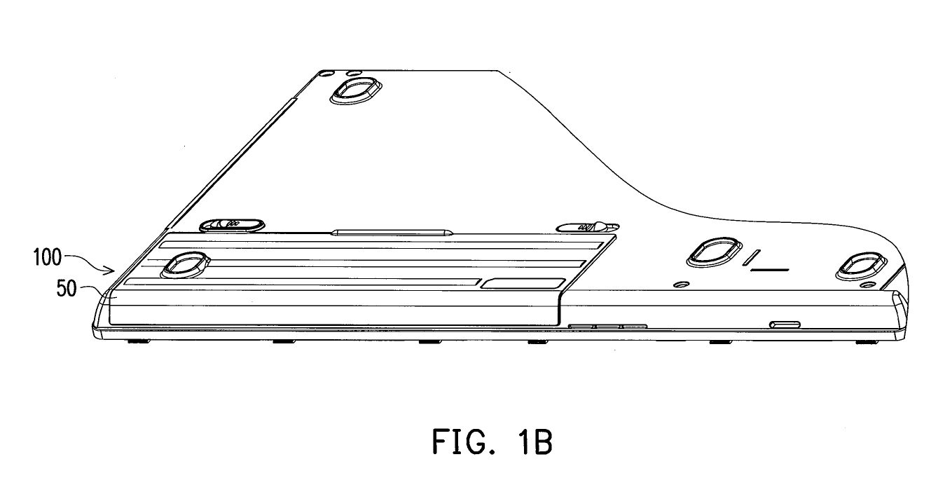

The fixture structure of a rotating shaft of the present embodiment is illustrated below for being applied to the notebook computer to fix the insert module, e.g., battery module. FIG. 1A is a perspective view of a fixture structure of a rotating shaft before being applied to the notebook to fix the insert module according to an embodiment of the present invention, and FIG. 1B is a perspective view of the fixture structure of a rotating shaft in FIG. 1A after being applied to fix the insert module. Referring to FIG. 1A and FIG. 1B, the fixture structure of a rotating shaft 100 of the present embodiment is disposed at the bottom of the notebook computer for fixing an insert module 50 (e.g., battery module) of the notebook computer.

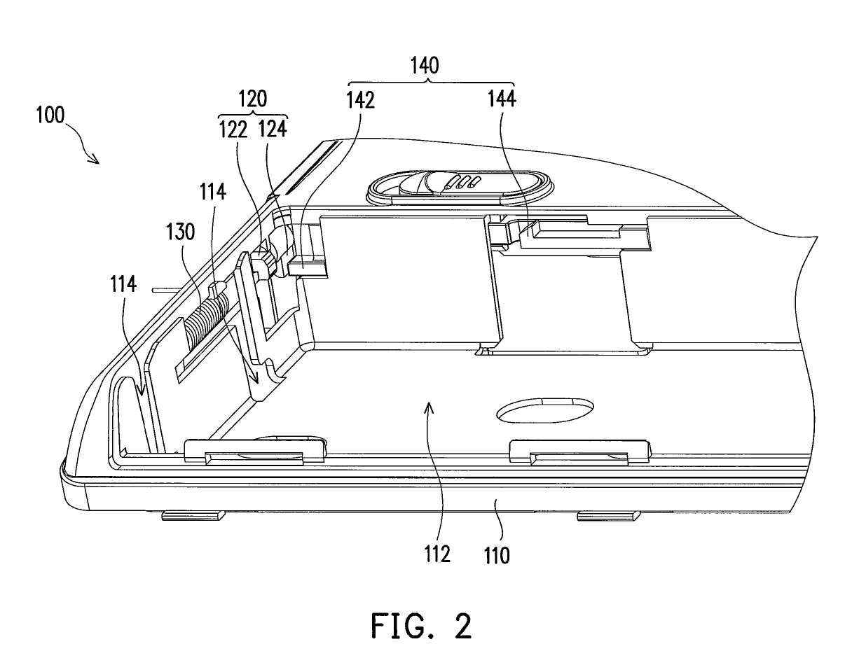

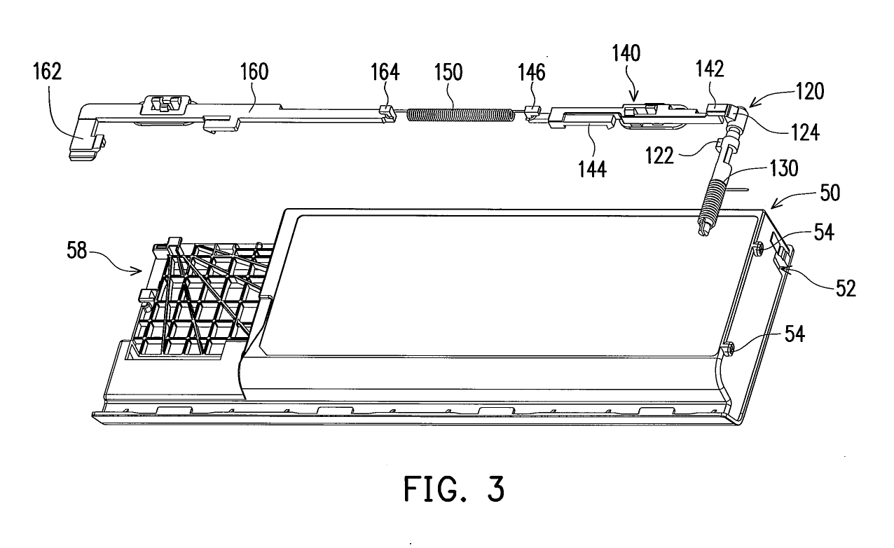

FIG. 2 is a partial enlarged view of FIG. 1A, and FIG. 3 is a perspective view of a part of the components of the fixture structure of a rotating shaft and the insert module of FIG. 1A. Referring to FIG. 2 and FIG. 3, the fixture structure of a rotating shaft 100 has a mainframe 110, a latching shaft 120, a first resetting component 130 and a latching rod 140. The mainframe 110 has an accommodating slot 112 and a plurality of chutes 114. The accommodating slot 112 is used to accommodate the insert module 50, and after the insert module 50 is placed into the accommodating slot 112, the sliding range of the insert module 50 relative to the accommodating slot 112 is limited by the matching of slide blocks 54 of the insert module 50 with the chutes 114. Moreover, the latching shaft 120, the first resetting component 130 and the latching rod 140 are all disposed in the mainframe 110, wherein the latching shaft 120 is pivoted at one side of the accommodating slot 112 of the mainframe 110. The first resetting component 130 is disposed on the mainframe 110 and used for driving the latching shaft 120, which has been forced to rotate, to return to the original position. The latching rod 140 may slide at another side of the accommodating slot 112 of the mainframe 110, and is substantially perpendicular to the latching shaft 120, thereby driving the latching shaft 120 to rotate.

Referring to FIG. 2 and FIG. 3, the latching shaft 120 has a retainer 122 and a bulge 124. After the latching shaft 120 rotates, the retainer 122 is engaged with a recess 52 of the insert module 50, thereby fixing the insert module 50 within the accommodating slot 112 of the mainframe 110. The latching rod 140 pushes the bulge 124 after being forced to move, so as to drive the latching shaft 120 to rotate, and thereby driving the retainer 122 to rotate as well, so the retainer 122 is disengaged from the recess 52 of the insert module 50. Moreover, the first resetting component 130 is disposed on the mainframe 110 for driving the latching shaft 120, which has been forced to rotate, to return to the original position. In the present embodiment, the first resetting component 130 may be an elastomer or a torsion spring. When the first resetting component 130 is a torsion spring, it is located around the latching shaft 120.

Referring to FIG. 2 and FIG. 3, the latching rod 140 has a contact portion 142. The contact portion 142 of the latching rod 140, which has been forced to move, pushes the bulge 124, so as to drive the latching shaft 120 to rotate. Moreover, the fixture structure of a rotating shaft 100 further comprises a second resetting component 150 disposed on the mainframe 110 for driving the latching rod 140, which has been forced to move, to return to the original position. In this embodiment, the second resetting component 150 may be an elastomer, for example, a spring, with one end being hooked to a hook portion 146 on the latching rod 140. As shown in FIG. 3, the fixture structure of a rotating shaft 100 further comprises another latching rod 160 slidably disposed at the side of the accommodating slot 112 of the mainframe 110, and the latching rod 160 has a hook 162 for engaging with another recess 58 of the insert module 50. Moreover, the other end of the second resetting component 150 hooks with the hook portion 164 on the latching rod 160.

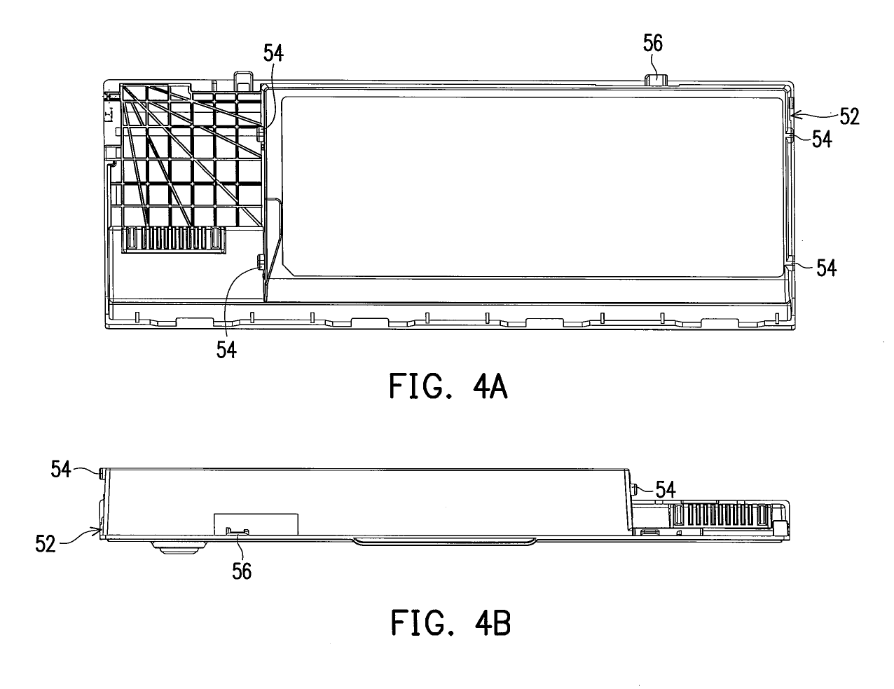

FIG. 4A and FIG. 4B are the top view and the rear view of the insert module of FIG. 3 respectively. Referring to FIG. 1B, FIG. 2, FIG. 4A and FIG. 4B, besides the above recess 52 and the slide block 54, the insert module 50 further has a bump 56. When it is intended to remove the insert module 50 from the mainframe 110, the structure interference forms between a stopper 144 of the latching rod 140, which has been forced to move under an external force, and the bump 56 of the insert module 50. After the structure interference occurs between the stopper 144 and the insert module 50, the position of the latching rod 140 is restricted, such that the latching rod 140 is not driven by the second resetting component 150 to return to the original position, thus, removing the insert module 50 from the mainframe 110 can be achieved with a single hand.

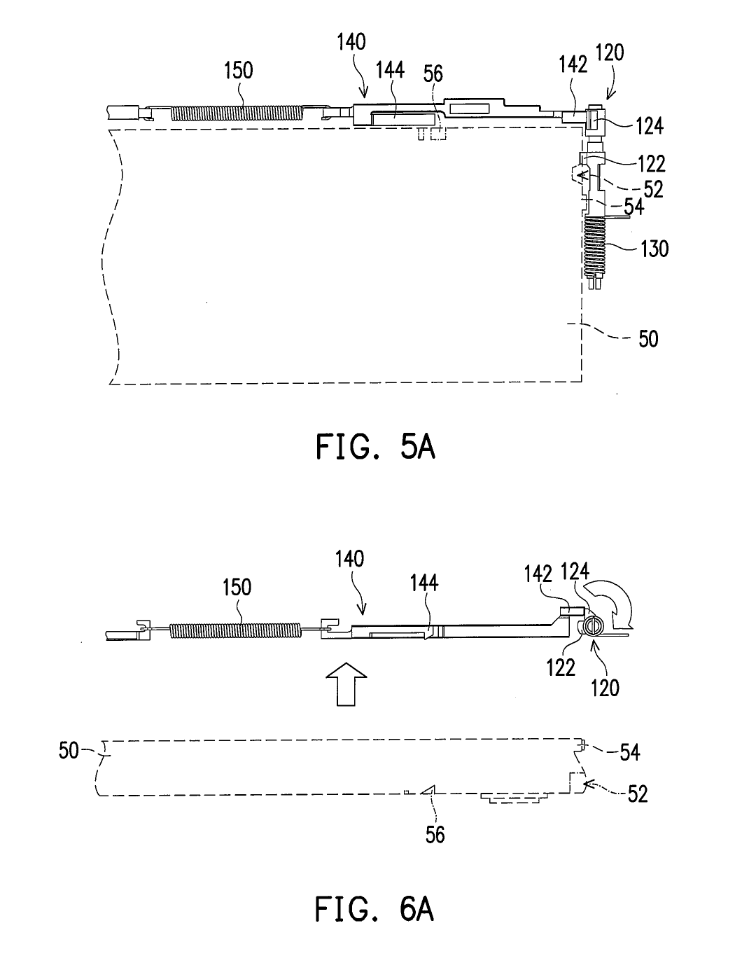

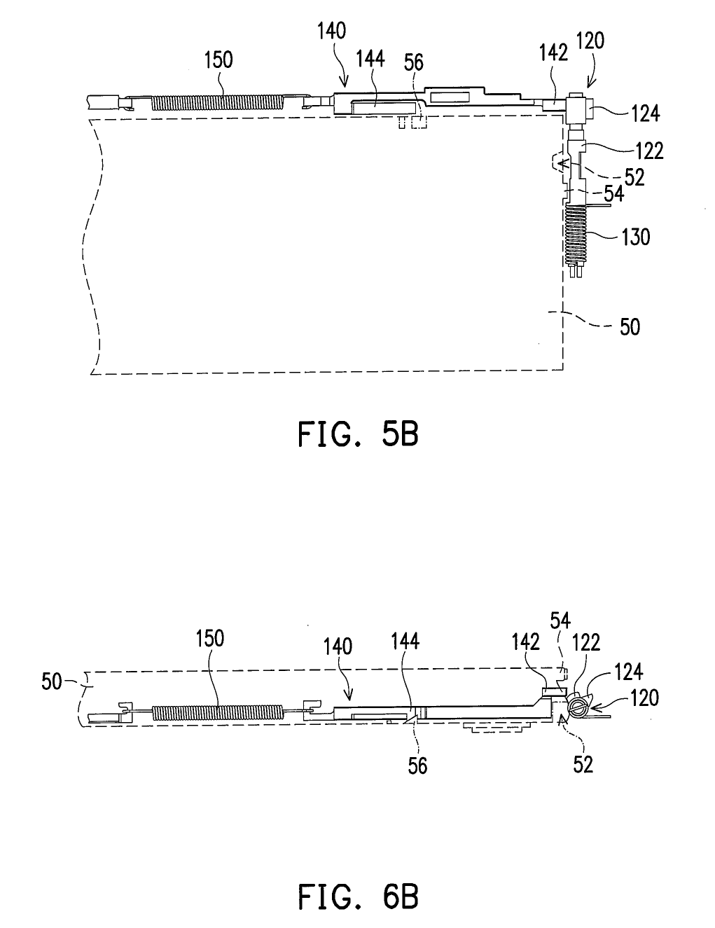

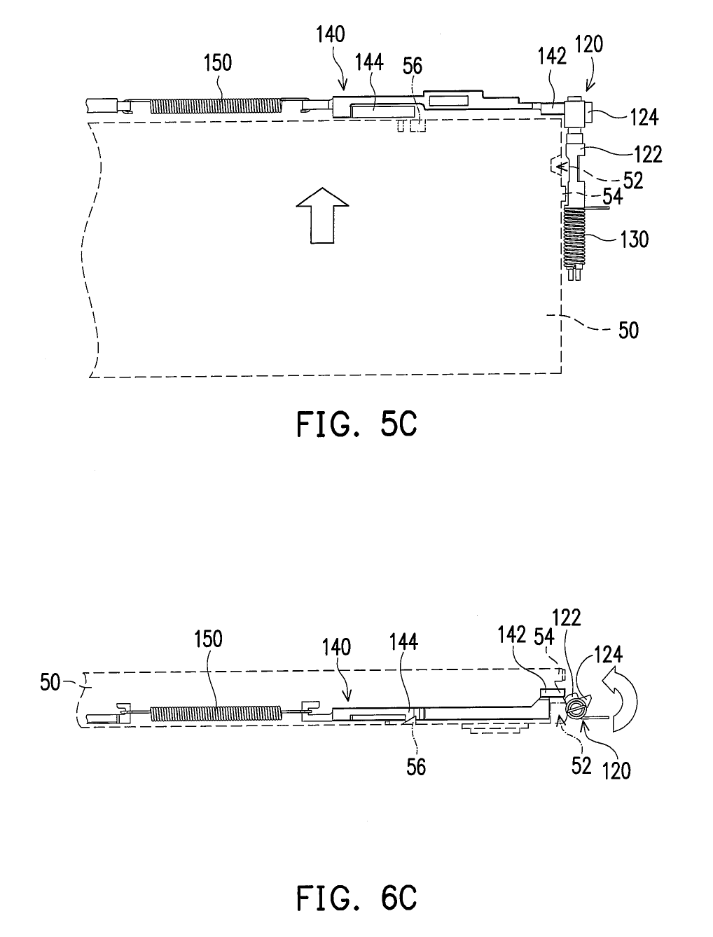

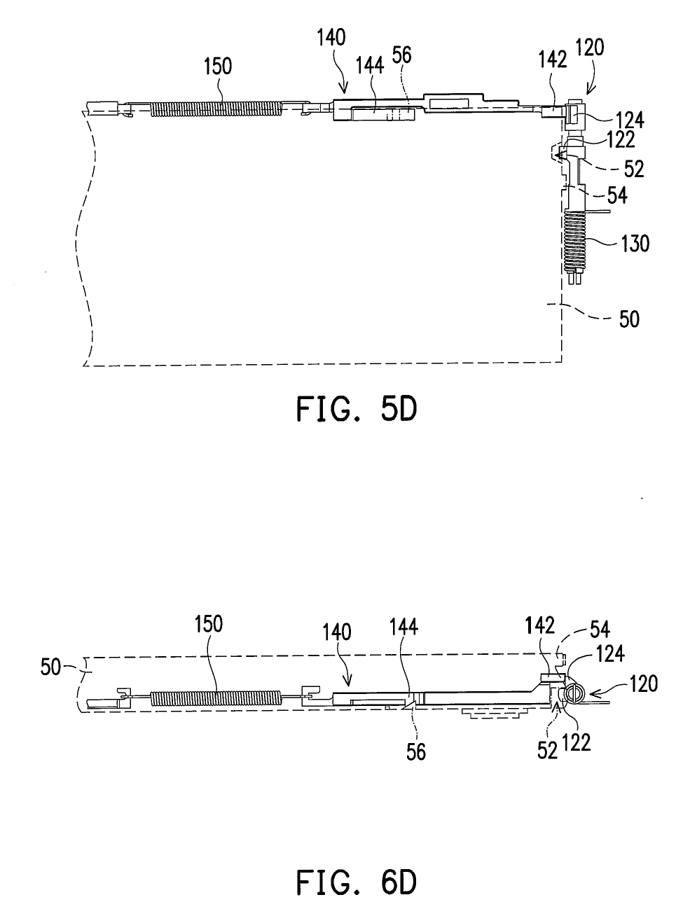

FIGS. 5A-5D are bottom views of the process of assembling the insert module of FIG. 1 to the fixture structure of a rotating shaft, and FIGS. 6A-6D are rear views of the process of assembling the insert module of FIG. 1 to the fixture structure of a rotating shaft. In order to show the assembly process clearly, the mainframe 110 of FIG. 2 is omitted in FIGS. 5A-5D and FIGS. 6A-6D. As shown in FIG. 5A, FIG. 6A, FIG. 5B and FIG. 6B, the user applies a force to place the insert module 50 into the accommodating slot 112 of FIG. 2. After the user applies a force to place the insert module 50 at a first position within the accommodating slot 112, the insert module 50 pushes the retainer 122 of the latching shaft 120 to drive the latching shaft 120 to rotate, such that the first resetting component 130 stores a potential energy. As shown in FIG. 5C and FIG. 6C, when the user applies a force to push the insert module 50 from the first position within the accommodating slot 112 of FIG. 2 towards the direction of the latching rod 140 to reach a second position, the first resetting component 130 releases the stored potential energy to drive the latching shaft 120 to return to the original position, such that the retainer 122 on the latching shaft 120 is engaged with the recess 52 of the insert module 50. As shown in FIG. 5D and FIG. 6D, finally, the insert module 50 is engaged and fixed within the accommodating slot 112.

During the process of assembling the insert module 50 to the fixture structure of a rotating shaft 100, the sliding range of the insert module 50 relative to the accommodating slot 112 is limited by the matching of the slide block 54 of the insert module 50 with the chutes 114 of the mainframe 110. In the above sliding range, the relative position between the insert module 50 and the mainframe 110 is fixed by the recess 52 of the insert module 50 and the retainer 122 of the latching shaft 120. In this embodiment, the chutes 114 of FIG. 2 are substantially L-shaped. Therefore, the insert module 50 moves to the first position relative to the accommodating slot 112 along the vertical track of the L-shaped chutes 114, then moves to the second position relative to the accommodating slot 112 along the horizontal track of the L-shaped chutes 114, thereby being fixed within the accommodating slot 112.

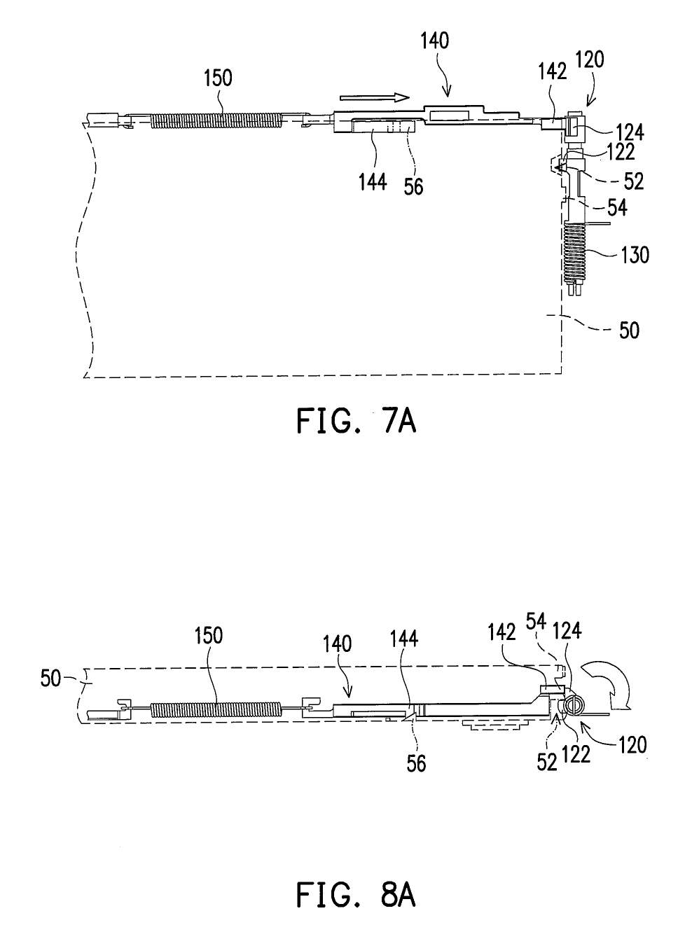

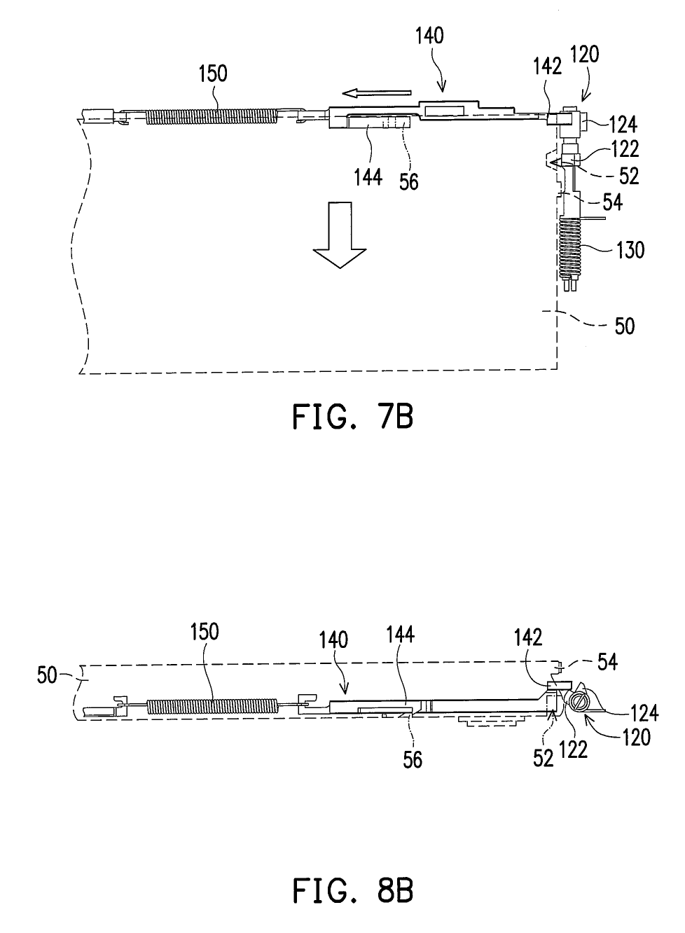

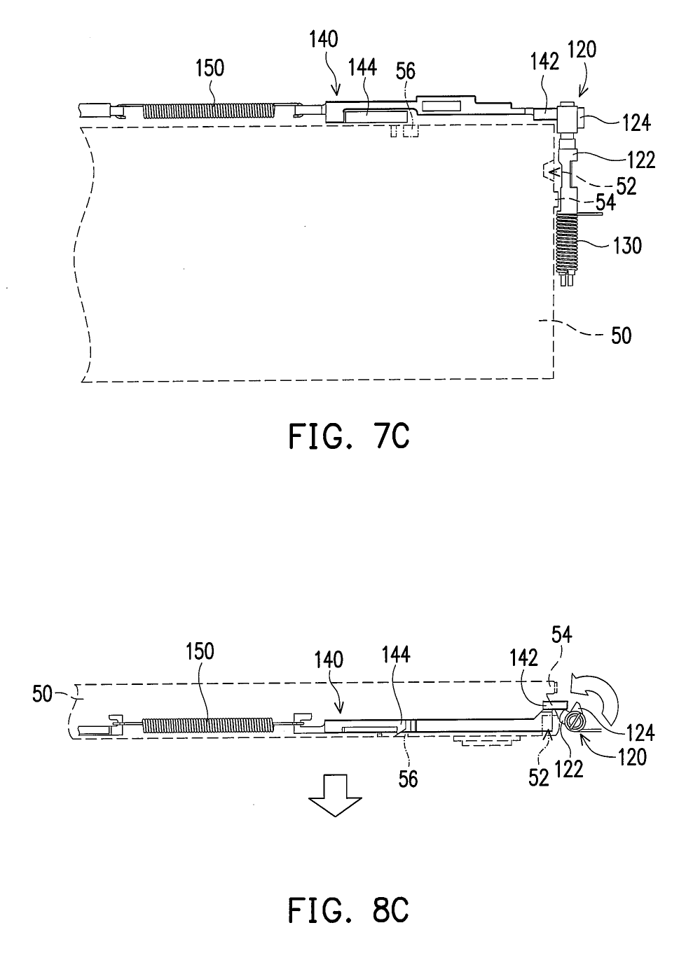

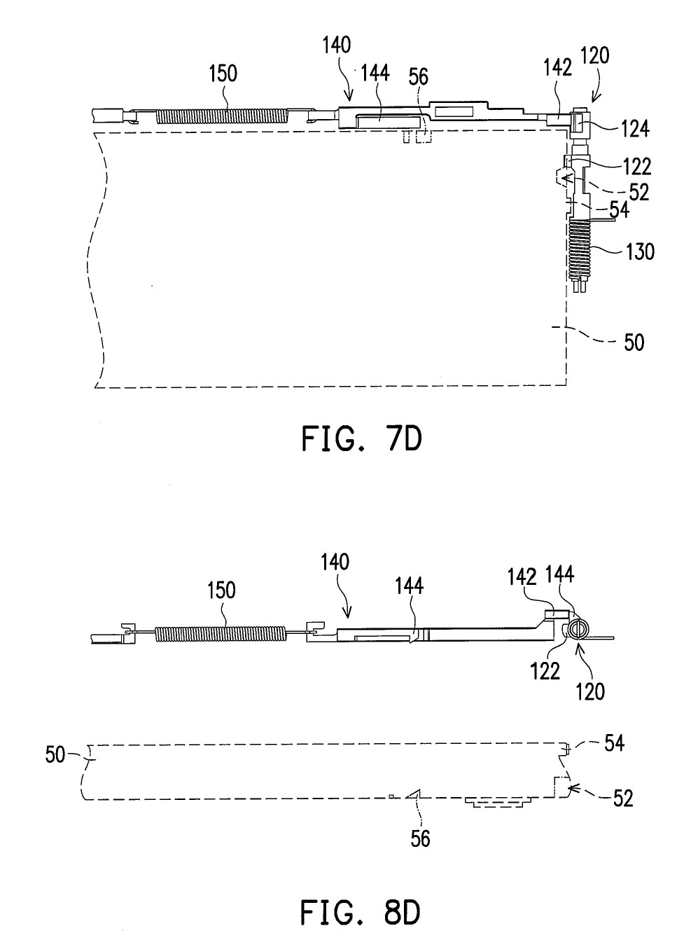

FIGS. 7A-7D are bottom views of the process of detaching the insert module of FIG. 1 from the fixture structure of a rotating shaft, and FIGS. 8A-8D are rear views of the process of detaching the insert module of FIG. 1 from the fixture structure of a rotating shaft. In order to show the detaching process clearly, the mainframe 110 of FIG. 2 is also omitted in FIGS. 7A-7D and FIGS. 8A-8D. As shown in FIG. 7A and FIG. 8A, the user applies a force to move the latching rod 140, such that the contact portion 142 of the latching rod 140 pushes the bulge 124 of the latching shaft 120, and thereby driving the latching shaft 120 to rotate.

As shown in FIG. 7B and FIG. 8B, after the contact portion 142 of the latching rod 140 pushes the bulge 124 of the latching shaft 120 to drive the latching shaft 120 to rotate, the retainer 122 is disengaged from the recess 52 as the latching shaft 120 rotates. Therefore, the structure interference between the retainer 122 and the recess 52 is released. Meanwhile, the latching shaft 130 after being forced to rotate makes the first resetting component 120 to store a potential energy, and the latching rod 140 after being forced to move makes the second resetting component 150 to store a potential energy. In order to enable the user to easily detach the insert module 50 from the accommodating slot 112 with a single hand, after the latching rod 140 moves for a certain distance, the stopper 144 of the latching rod 140 is engaged with the bump 56 of the insert module 50, such that the structure interference continuously occurs between the contact portion 142 of the latching rod 140 and the bulge 124 of the latching shaft 120, and the second resetting component 150 does not release the stored potential energy. Therefore, through the matching between the slide block 54 of the insert module 50 and the L-shaped chutes 114 of the mainframe 110 of FIG. 2, the user may apply a force to horizontally push the insert module 50 from the second position of the accommodating slot 112 in FIG. 2 towards a direction far away from the latching rod 140 to reach the first position.

As shown in FIG. 7C and FIG. 8C, when the user applies a force to push the insert module 50 from the second position to the first position, the bump 56 of the insert module 50 is not engaged with the stopper 144 of the latching rod 140 any more, such that the second resetting component 150 releases the stored potential energy to drive the latching rod 140 to return to the original position. Meanwhile, the structure interference still occurs between the insert module 50 and the retainer 122, such that the first resetting component 130 does not release the stored potential energy. The user applies a force to take the insert module 50 out of the accommodating slot 112 of FIG. 2. As shown in FIG. 7D and FIG. 8D, after the insert module 50 has been removed from the accommodating slot 112 of FIG. 2, the structure interference is not formed between the insert module 50 and the retainer 122 any more. The first resetting component 130 releases the stored potential energy to drive the latching shaft 120 to rotate, such that the retainer 122 and the bulge 124 are returned to the original position respectively.

To sum up, the rotating stroke of the latching shaft is used to replace the moving stroke of the conventional tenon so as to provide the function of structure interference, and thereby the required operation space may be reduced. Therefore, when the present invention is applied for fixing the battery of the notebook computer, and the accommodating slot (i.e., battery-accommodating slot) is adjacent to the side of the housing of the notebook, the space between the accommodating slot and the side of the housing is still large enough for pivoting the latching shaft of the present invention, and the rotating course of the latching shaft is utilized to provide the function of structure interference, which facilitates the volume miniaturization of the notebook computer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A fixture structure of a rotating shaft, for fixing an insert module, comprising:
a mainframe, having an accommodating slot for accommodating the insert module;
a latching shaft, pivotally disposed at one side of the accommodating slot of the mainframe, having a retainer and a bulge, wherein the retainer is adopted for being engaged with a recess of the insert module and thereby fixing the insert module within the accommodating slot;
a first resetting component, disposed on the mainframe, for driving the latching shaft being forcedly rotated to return to the original position; and
a latching rod, disposed at another side of the accommodating slot of the mainframe, wherein the latching rod is substantially perpendicular to the latching shaft, for bearing against and pushing the bulge after being forced to move, thereby driving the latching shaft to rotate, such that the retainer is disengaged from the recess of the insert module.

2. The fixture structure of a rotating shaft as claimed in claim 1, wherein the latching rod is slidably disposed on the mainframe.

3. The fixture structure of a rotating shaft as claimed in claim 1, wherein when the insert module is placed in a first position of the accommodating slot, the insert module pushes the retainer to drive the latching shaft to rotate, and the first resetting component stores a potential energy; and when the insert module is forced to move from the first position to a second position, the first resetting component releases the potential energy to drive the latching shaft being forcedly rotated, to return to the original position, and thereby the retainer is engaged with the recess of the insert module.

4. The fixture structure of a rotating shaft as claimed in claim 1, wherein the first resetting component is an elastomer.

5. The fixture structure of a rotating shaft as claimed in claim 1, wherein the first resetting component is a torsion spring.

6. The fixture structure of a rotating shaft as claimed in claim 5, wherein the torsion spring is located around the latching shaft.

7. The fixture structure of a rotating shaft as claimed in claim 1, wherein the insert module is a battery module.

8. The fixture structure of a rotating shaft as claimed in claim 1, further comprising:
a second resetting component, disposed on the mainframe, for driving the latching rod being forcedly moved to the original position.

9. The fixture structure of a rotating shaft as claimed in claim 8, wherein the second resetting component is an elastomer.

10. The fixture structure of a rotating shaft as claimed in claim 8, wherein the second resetting component is a spring.

11. The fixture structure of a rotating shaft as claimed in claim 8, wherein the insert module has a bump, the latching rod further has a stopper, and when the latching rod bears against the bulge after being forced to move, the stopper is engaged with the bump, thereby limiting the position of the latching rod, and stopping the latching rod from being driven by the second resetting component to return to the original position of the latching rod.
